(19) United States
(12) Patent Application Publication
(10) Pub. No.: US 2008/0062106 A1
(43) Pub. Date: Mar. 13, 2008

(54) SYSTEM FOR INCREASING CIRCUIT RELIABILITY AND METHOD THEREOF

(75) Inventor: Huai-Yuan Tseng, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: INDUSTRIAL TECHNOLOGY RESEARCH INSTITUTE, Hsinchu (TW)

(21) Appl. No.: 11/567,216

(22) Filed: Dec. 6, 2006

(30) Foreign Application Priority Data
Sep. 12, 2006 (TW) 95133613

(51) Int. Cl. G09G 3/36

(52) U.S. Cl. 345/92

(57) ABSTRACT

A system for increasing circuit reliability and a method thereof are disclosed. A second thin film transistor (TFT) is used as a contrastive group of a first TFT in the circuit, and variations of device parameters of the first TFT are estimated through the contrastive group. The operation environment of the first TFT is adjusted according to the variations of device parameters of the first TFT so as to compensate the variations of device parameters of the first TFT. Thereby the driving ability of the first TFT can be maintained.

### CROSS-REFERENCE TO RELATED APPLICATION

This application claims the priority benefit of Taiwan application serial no. 95133613, filed Sep. 12, 2006. All disclosure of the Taiwan application is incorporated herein by reference.

### BACKGROUND OF THE INVENTION

1. Field of the Invention

The present invention relates to a system for increasing circuit reliability and a method thereof. More particularly, the present invention relates to a system for increasing the reliability of a thin film transistor in a circuit and a method thereof.

2. Description of Related Art

In an active array liquid crystal display (LCD), a thin film transistor (TFT) is required in each sub-pixel to serve as a switch for precisely controlling the grey scale of each pixel. Thus, active array LCD is broadly applied to large-surface and high-definition displays, accordingly, thin film transistor LCD (TFT-LCD) has become the major display in today's display market and is broadly applied in notebook computers, digital cameras, high definition TVs, and so on.

Recently, integrated TFT gate driving circuit has become more focused as such circuit can reduce the cost of external gate driving IC. However, today's TFT has low reliability, after a TFT in a circuit works for some time, device parameters thereof, such as threshold voltage and leakage current, may change due to the affection of driving voltage, turn-on current, and operation temperature etc, and further the operation of the circuit or the display quality of the display may be affected.

FIG. 1 is a curve illustrating the changes of a threshold voltage and a drain current with time. Referring to FIG. 1, after the display is used for some time, the bias supplied to the TFT in the integrated driving circuit causes the threshold voltage VT of the TFT to increase along time. It can be understood from formula I_{d}=(W/L)μₙCₒₓ(V_{GS}−T_{T})² that the drain current of the TFT decreases along time under constant bias V_{GS} due to the increase of the threshold voltage. When the drain current I_{d} decreases to the threshold value I_{fail}, the driving ability of the TFT becomes insufficient, so that the driving circuit becomes invalid and accordingly the display produces incorrect images.

Accordingly, in the application of TFT, the reliability of the TFT has to be compensated through device structure design, circuit compensation design, and system adjustment. Presently, U.S. patents No. US20050140599 and US20050067970 have been published for resolving the problem of threshold voltage drift in amorphous Si TFT when amorphous Si TFT is used for driving organic light-emitting display (OLED).

In U.S. Patent No. US20050140599, an external scan signal is adopted for reducing the source/drain voltage of the TFT to negative voltage, so as to compensate the drifted threshold voltage. However, the adoption of the external scan signal may increase the complexity of the circuit layout and parasite capacitance may be produced due to jumper wire.

In U.S. Patent No. US20050067970, a dual gate amorphous Si TFT different from conventional process and an external transistor are adopted for compensating the drifted threshold voltage. Since the device structure has to be changed, such design incur high cost in actual process.

### SUMMARY OF THE INVENTION

Accordingly, the present invention is directed to a system for increasing circuit reliability, wherein variations of device parameters of a thin film transistor (TFT) are estimated and the operation environment of the TFT is adjusted according to the variations to maintain the driving ability of the TFT, so that the TFT can be more reliable.

According to another aspect of the present invention, a method for increasing circuit reliability is provided, wherein variations of device parameters of a TFT are estimated and the operation environment of the TFT is adjusted, so that device property drift of the TFT can be timely compensated.

The present invention provides a system for increasing circuit reliability. The system includes a transistor circuit and an estimating/adjusting device. Wherein the transistor circuit includes a first TFT and the estimating/adjusting device is coupled to the transistor circuit for estimating variations of device parameters of the first TFT and adjusting the operation environment of the first TFT accordingly.

According to another aspect of the present invention, a method for increasing circuit reliability is further provided. The circuit includes at least a first TFT. First, a second TFT is provided to serve as a contrastive group of the first TFT. Next, the variations of device parameters of the second TFT are calculated. Eventually, the operation environment of the first TFT is adjusted according to the variations of device parameters of the second TFT.

According to the present invention, the variations of device parameters of a TFT are timely compensated by estimating the variations of device parameters of the TFT and adjusting the operation environment of the TFT, so that the driving ability of the TFT can be maintained while device parameters thereof drift, accordingly the TFT can be more reliable.

In order to make the aforementioned and other objects, features and advantages of the present invention comprehensible, a preferred embodiment accompanied with figures is described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a graph illustrating the changes of a threshold voltage and a drain current with time.

FIG. 2 is a block diagram of a system for increasing circuit reliability according to an embodiment of the present invention.

FIG. 3 is a circuit diagram of a transistor circuit.

FIG. 4(a) is a graph illustrating the changes of the threshold voltage VT of a thin film transistor (TFT) with time.

FIG. 4(b) is a graph illustrating the changes of the gate-source voltage V_{gs} of a TFT with time.

FIG. 4(c) is a graph illustrating the changes of the drain current I_{d} of a TFT with time.

FIG. 5 is a block diagram of a system for increasing circuit reliability according to an embodiment of the present invention.

FIG. 6 is a flowchart illustrating a method for increasing circuit reliability according to an embodiment of the present invention.

FIG. 7 is a flowchart illustrating a method for increasing circuit reliability according to another embodiment of the present invention.

FIG. 8 is a flowchart illustrating a method for increasing circuit reliability according to yet another embodiment of the present invention.

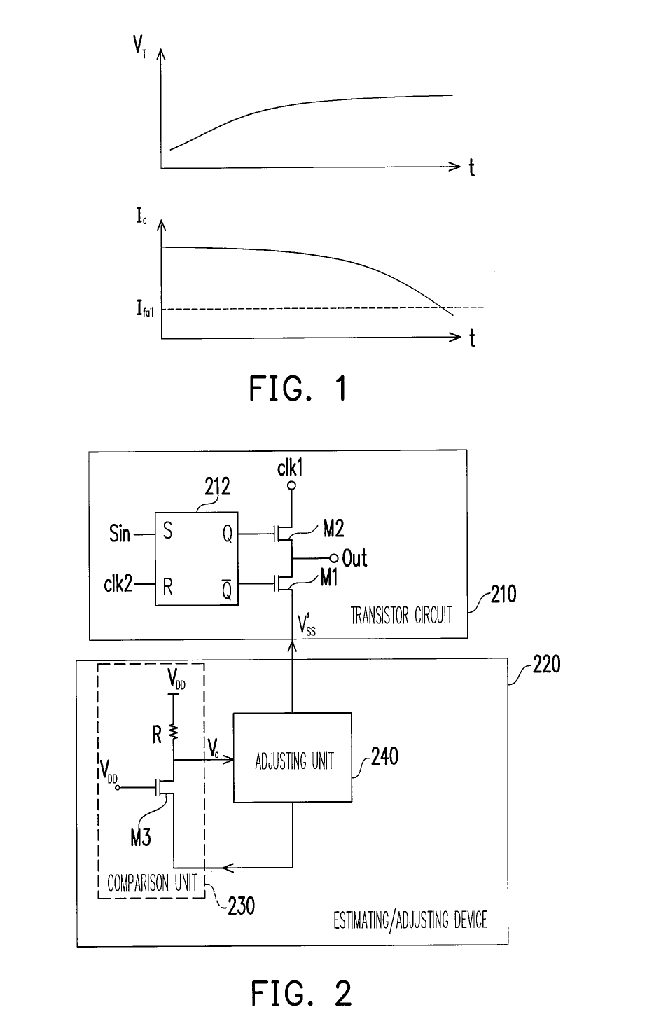

### DESCRIPTION OF EMBODIMENTS

Due to reliability concern of existing thin film transistor (TFT), the operation of a circuit is affected when the device parameters (such as threshold voltage, drain current, and leakage current etc) of a TFT in the circuit change with time.

For example, when the gate of a TFT is supplied with a bias for a long time, the threshold voltage V_{T} of the TFT changes along time, and the relationship between the variation ΔV_{T} and the bias supplied to the gate is:

$$Δ {V}_{T} = {( {V}_{gs} - {V}_{T 0} )}^{a} \cdot \{ 1 - exp [ - {( \frac{t}{τ} )}^{b} ] \}$$

### Wherein V_{gs} represents gate-source voltage, V_{T0} represents the original threshold voltage of the TFT, t denotes time, τ denotes the constant of temperature effect, and a, b are constants.

Assuming that the TFT operates at a saturation region, then the drain current I_{d} is:

$${I}_{d} = \frac{W}{L} {μ}_{n} {{C}_{ox} ( {V}_{gs} - {V}_{T} )}^{2}$$

Wherein W represents the channel width of the TFT, L represents the channel length of the TFT, μₙ denotes the electron mobility rate, Cₒₓ represents the oxide capacitance per unit area. Accordingly, if the bias supplied to the gate is constant, when the threshold voltage V_{T} of the TFT changes, the drain current I_{d} of the TFT changes to

$${I}_{d}^{′} = \frac{W}{L} {μ}_{n} {{C}_{ox} [ {V}_{gs} - ( {V}_{T} + Δ {V}_{T} ) ]}^{2} ,$$

which may even cause insufficient driving ability of the TFT.

Accordingly, a system for increasing circuit reliability and a method thereof are provided in an embodiment of the present invention, wherein the variations of device parameters of a TFT are estimated and the operation environment of the TFT is adjusted accordingly. Some embodiments of the present invention will be described below. The threshold voltage of a TFT is used for explaining the variations of device parameters; however the present invention is not limited thereto.

FIG. 2 is a block diagram of a system for increasing circuit reliability according to an embodiment of the present invention. Referring to FIG. 2, the system includes a transistor circuit 210 and an estimating/adjusting device 220. Wherein the transistor circuit 210 includes a first TFT M1 and the estimating/adjusting device 220 is coupled to the transistor circuit 210 for estimating the variation of the threshold voltage of the TFT M1 and adjusting the operation environment of the TFT M1.

In the present embodiment, a shift register is used as an example of the transistor circuit 210, and the transistor circuit 210 includes a TFT M1, a TFT M2, and a flip-flop 212. Wherein the S input terminal of the flip-flop 212 receives an input signal Sin, and the R input terminal thereof receives a clock signal Clk2. The Q output terminal of the flip-flop 212 is coupled to the gate of the TFT M2 for turning on the TFT M2 and for allowing the source of the TFT M2 to output an output signal after the clock signal Clk1 received by the drain of the TFT M2 is dropped by the source-drain. The inverse Q output terminal of the flip-flop 212 is coupled to the gate of the TFT M1, and when the inverse Q output terminal outputs a high voltage level, the TFT M1 is turned on and the output signal Out is pulled down to a low voltage level. In the present embodiment, the TFTs M1 and M2 may include amorphous Si TFTs or other types of TFTs.

During the actual operation of the circuit, the inverse Q output terminal remains at a high voltage level most of the time to maintain the output signal Out to be at a low voltage level, thus, the gate of the TFT M1 is supplied with a high voltage most of the time, accordingly variation of threshold voltage may be produced more easily. In the present embodiment, the estimating/adjusting device 220 coupled to the transistor circuit 210 can estimate the variation of the threshold voltage of the TFT M1 and adjust the operation environment of the TFT M1, wherein the operation environment may include drain current, gate voltage, and source voltage etc.

The estimating/adjusting device 220 includes a contrasting unit 230 and an adjusting unit 240. The contrasting unit 230 contrasts the TFT M1 with a second TFT M3. The first terminal of the resistor R in the contrasting unlit 230 receives a reference voltage source V_{DD}, and the second terminal thereof is coupled to the drain of the TFT M3. The gate of the TFT M3 in the contrasting unit 230 receives the reference voltage source V_{DD}, the source thereof receives the adjusting signal V′_{SS}, and the drain thereof outputs a contrasting signal V_{C}, and

$${V}_{C} = {V}_{DD} - β [ ( {V}_{DD} - {V}_{s} - {V}_{T} ) {V}_{C} - \frac{{V}_{C}^{2}}{2} ] . R , wherein$$

$$β = \frac{W}{L} {μ}_{n} {C}_{ox} .$$

After receiving the contrasting signal V_{C}, the adjusting unit 240 calculates the threshold voltage of the TFT M3 according to the contrasting signal V_{C}, thus, the threshold voltage V_{T} of the TFT M3 is

$${V}_{T} = {V}_{DD} - \frac{\frac{{V}_{DD} - {V}_{SS} - {V}_{C}}{R \cdot β} + \frac{{V}_{C}^{2}}{2}}{{V}_{C}} . \qquad ( 1 )$$

In an embodiment of the present invention, the TFT M3 is used for contrasting the TFT M1, thus, the threshold voltage calculated by the adjusting unit 240 is used for estimating the variation ΔV_{T} of the threshold voltage of the TFT M1. Moreover, the adjusting unit 240 outputs an adjusting signal V′_{SS} to the source of the TFT M1 according to the variation ΔV_{T} of the threshold voltage. In other words, when the adjusting unit 240 estimates the variation ΔV_{T} of the threshold voltage, the adjusting unit 240 adjusts the gate-source voltage V_{gs} of the TFT M1 to V′_{gs}=V_{gs}+ΔV_{T} to compensate the variation ΔV_{T} of the threshold voltage of the TFT M1, and the drain current I_{d} of the TFT M1 is changed to I′_{d}, and the value of I′_{d} is

$$\begin{matrix}{I}_{d}^{′} = \frac{W}{L} {μ}_{n} {{C}_{ox} [ {V}_{gs}^{′} - ( {V}_{T} + Δ {V}_{T} ) ]}^{2} \\ = \frac{W}{L} {μ}_{n} {{C}_{ox} [ {V}_{gs} + Δ {V}_{T} - ( {V}_{T} + Δ {V}_{T} ) ]}^{2} \\ = \frac{W}{L} {μ}_{n} {{C}_{ox} [ {V}_{gs} - {V}_{T} ]}^{2} = {I}_{d}\end{matrix}$$

As shown in foregoing formula, when V_{gs} is adjusted to V′_{gs}=V_{gs}+ΔV_{T}, then I′_{d}=I_{d}, SO that even though the threshold voltage V_{T} of the TFT M1 changes, the drain current I_{d} of the TFT M1 is still maintained at a particular value, accordingly the driving ability of the TFT M1 can be maintained.

In the present embodiment, since the TFT M3 is used for simulating the TFT M1, thus, the adjusting signal V′_{SS} output by the adjusting unit 240 is also output to the source of the TFT M3, namely, the source of the TFT M3 is adjusted at the same time to allow the TFT M3 to be contrasted with the TFT M1.

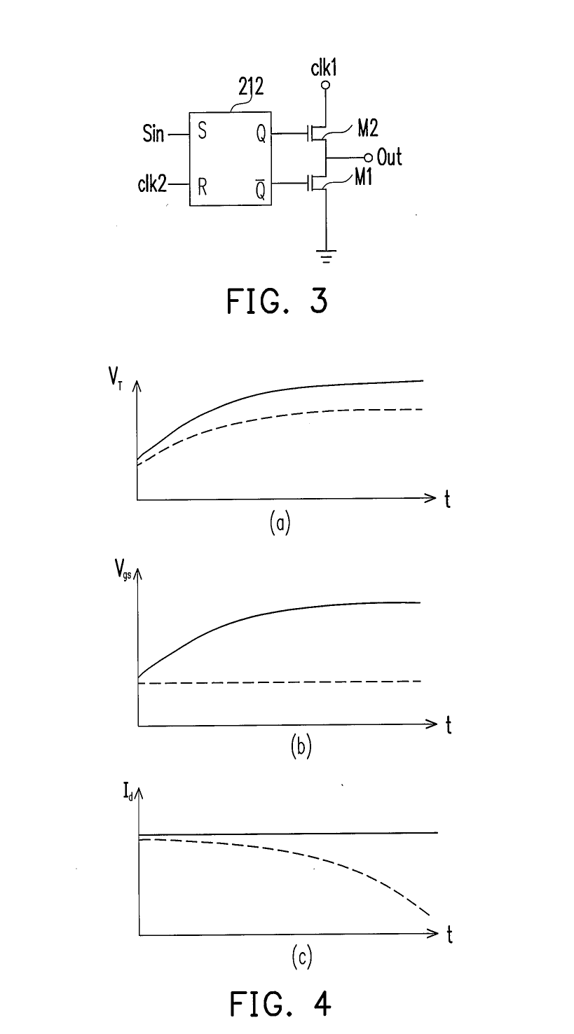

In the present embodiment, if the source of the TFT M1 in FIG. 2 is grounded but does not receive the adjusting signal V′_{SS}, namely, as shown in FIG. 3, the transistor circuit 210 is not coupled to the estimating/adjusting device 220, after the circuit in FIG. 3 operates for some time, the threshold voltage of TFT M1 increases along time due to the bias supplied thereto, accordingly the drain current of the TFT M1 decreases.

FIG. 4(a) is a graph illustrating the changes of the threshold voltage V_{T} of a thin film transistor (TFT) with time, FIG. 4(b) is a graph illustrating the changes of the gate-source voltage V_{gs} of a TFT with time, and FIG. 4(c) is a graph illustrating the changes of the drain current I_{d} of a TFT with time. Referring to FIG. 3 and FIG. 4, all the dotted lines in FIG. 4 represent the curves of the threshold voltage V_{T}, the gate-source voltage V_{gs}, and the drain current I_{d} of TFT M1 in FIG. 3, and it is assumed that the inverse Q output terminal of the flip-flop 212 keeps outputting high voltage level. It can be observed from the dotted lines in FIG. 4 that when the threshold voltage V_{T} of TFT M1 increases with time, the drain current I_{d} decreases under constant gate-source voltage V_{gs}, or even insufficient driving ability of the TFT will be caused after long time operation.

Referring to FIG. 2 and FIG. 4 again, all the continuous lines in FIG. 4 represent the curves of the gate-source voltage V_{gs}, the threshold voltage V_{T}, and the drain current I_{d} of the TFT M1 in FIG. 2, and it is assumed that the inverse Q output terminal of the flip-flop 212 outputs high voltage level. It can be observed from the lines in FIG. 4 that the threshold voltage V_{T} of TFT M1 increases along with time. However, the adjusting unit 240 has estimated the variation of the threshold voltage V_{T} and output the adjusting signal V′_{SS} according to the variation, thus, when the threshold voltage V_{T} increases, the adjusting unit 240 reduces the source voltage of TFT M1 through the adjusting signal V′_{SS}, so as to increase the gate-source voltage V_{gs} and maintain the drain current I_{d} of TFT M1, so that the driving ability of TFT M1 won't be reduced due to the drift of the threshold voltage, and accordingly the reliability of the transistor circuit can be improved.

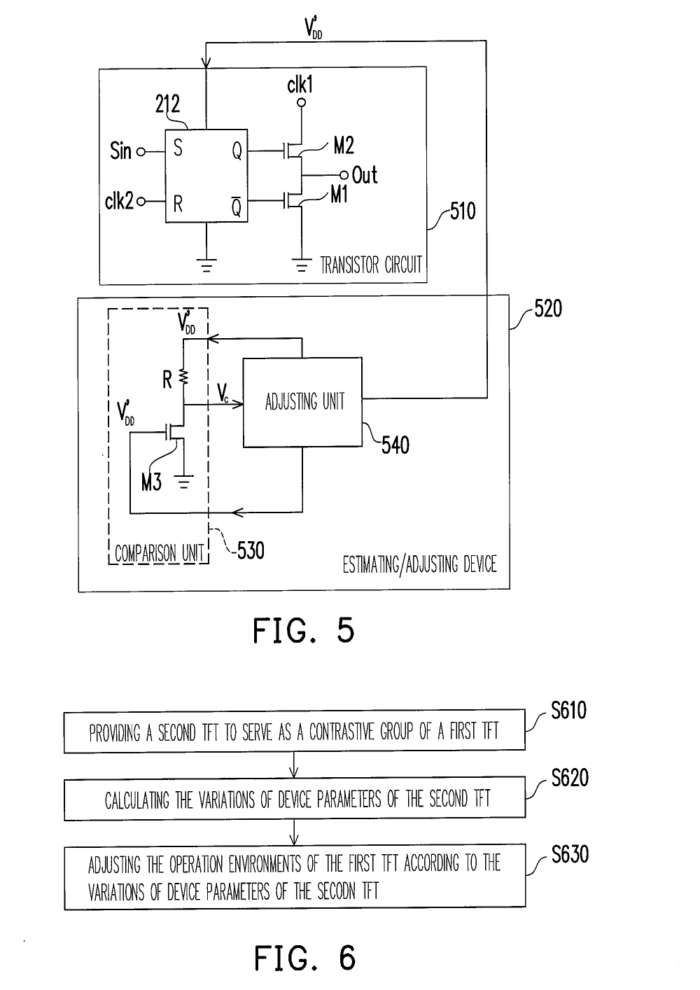

Another embodiment of the present invention will be described below so that those having ordinary skill in the art could implement the present invention easily. FIG. 5 is a block diagram of a system for increasing circuit reliability according to an embodiment of the present invention. The system includes a transistor circuit 510 and an estimating/adjusting device 520. The transistor circuit 510 in the present embodiment is similar to the transistor circuit 210 in FIG. 2 and the estimating/adjusting device 520 is also similar to the estimating/adjusting device 220 in FIG. 2, therefore they will not be described herein.

However, the difference between the present embodiment and the embodiment in FIG. 2 is that the adjusting unit 540 outputs an adjusting signal V′_{DD} to the voltage source input terminal of the flip-flop 212 according to the estimated variation of the threshold voltage, so as to adjust the reference voltage source of flip-flop 212, moreover, the high voltage level output by the inverse Q output terminal of flip-flop 212 changes along with the adjustment of the reference voltage source, and the voltage at the gate of the TFT M1 is also adjusted accordingly. In other words, when the transistor circuit 510 is used for some time and the threshold voltage of the TFT M1 is increased, the adjusting unit 540 adjusts the reference voltage source of the flip-flop 212 through the adjusting signal V′_{DD} to increase the voltage at the gate of TFT M1, so as to compensate the variation of the threshold voltage.

In the present embodiment, the TFT M3 is used for simulating the TFT M1, thus, the adjusting signal V′_{DD} output by the adjusting unit 540 is also output to the gate of the TFT M3 and the first terminal of the resistor R, that is, the reference voltage source of the contrasting unit 530 is adjusted at the same time to allow the TFT M3 to be contrasted with the TFT M1.

It should be mentioned here that even though a possible pattern of the system for increasing circuit reliability has been described in the two embodiments described above, it should be understood by those skilled in the art that circuits applied to different fields have different designs, thus, the present invention should not be limited to the possible pattern described above. In other words, it is within the scope of the present invention as long as the variations of device parameters are estimated and the operation environment is adjusted accordingly. Next, a few embodiment of the method for increasing circuit reliability will be described below so that those having ordinary knowledge of the art can implement the present invention easily.

FIG. 6 is a flowchart illustrating a method for increasing circuit reliability according to an embodiment of the present invention. In the present embodiment, the circuit includes a first TFT which may be an amorphous Si TFT or other type of TFT.

Referring to FIG. 6, first, a second TFT is provided as the contrastive group of a first TFT (step S610). Since during actual operation of the circuit, drifts of device parameters, such as variations in threshold voltage, leakage current, and drain current, may be produced after the TFT is turned on for a long time, in the present embodiment, a second TFT which is maintained as turned-on is used as a contrastive group of the first TFT for estimating the variations of device parameters.

Next, the variations of device parameters of the second TFT are calculated (step S620). In step S620, the device parameters of the second TFT can be calculated by measuring the voltage or the current of the second TFT, and so as to obtain the variations of device parameters of the second TFT.

Finally, the operation environment of the first TFT is adjusted according to the variations of device parameters of the second TFT (step S630). In step S630, since the second TFT is used as the contrastive group of the first TFT, the calculated variations of device parameters of the second TFT are used for estimating the variations of device parameters of the first TFT and adjusting the operation environment of the first TFT, so as to compensate the variations of device parameters. The method for changing the operation environment of the first TFT includes changing the drain current, the gate voltage, and the source voltage etc of the TFT.

Two embodiments of the method for increasing circuit reliability in the present invention will be further described below, so that those having ordinary skill in the art can implement the present invention easily. For the convenience of description, threshold voltage will be used as an example of device parameters throughout.

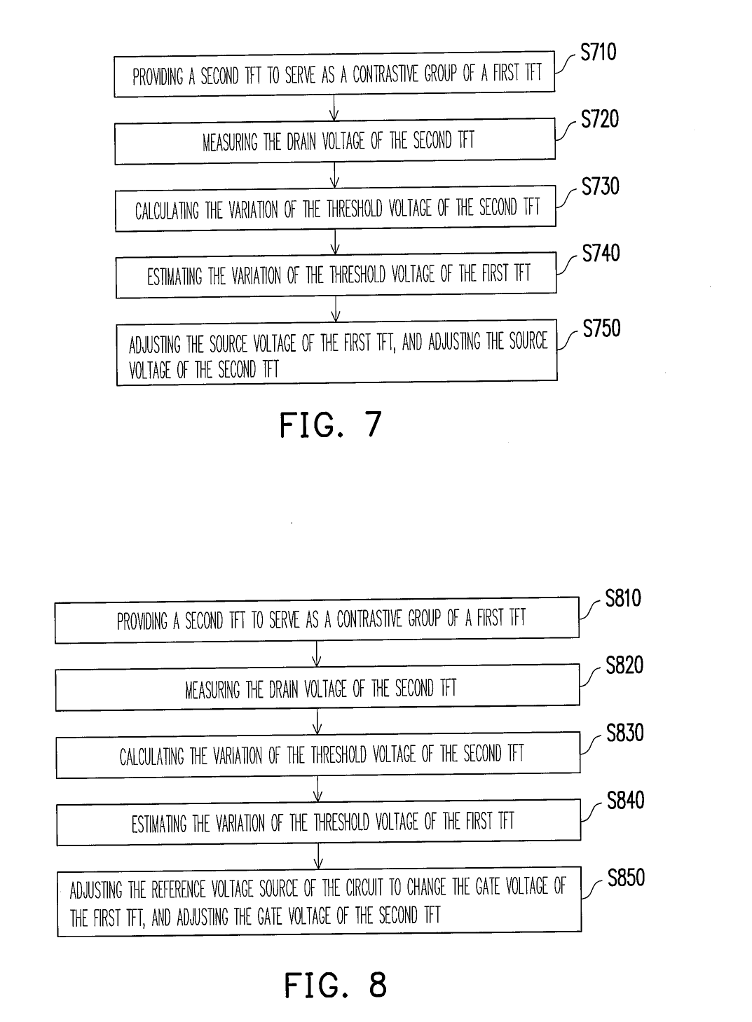

FIG. 7 is a flowchart illustrating a method for increasing circuit reliability according to another embodiment of the present invention. In the present embodiment, the circuit includes a first TFT which may be an amorphous Si TFT or other type of TFT. Referring to FIG. 7, first, a second TFT is provided as a contrastive group of the first TFT (step S710). During the actual operation of the circuit, drifts of device parameters may be produced in the TFT after the TFT is turned on for a long time, such as variations in threshold voltage, leakage current, and drain current etc. Thus, in the present embodiment, a second TFT which remains on is used as a contrastive group of the first TFT for estimating variations of device parameters of the first TFT.

Next, the drain voltage of the second TFT is measured (step S720), and the variation in threshold voltage of the second TFT is calculated according to the measured drain voltage (step S730). In the present embodiment, since the second TFT is used as a contrastive group, the voltages supplied to the gate and the source of the second TFT, the inputted reference voltage source, and peripheral circuit impedances are all known, after the drain voltage is measured, the threshold voltage of the second TFT can be calculated according to the measured drain voltage. Variation of the threshold voltage can be obtained according to the calculated threshold voltage. In step S730, the method for calculating variation of the threshold voltage of the second TFT may be implemented by the expression (1) used by the adjusting unit in FIG. 2 for calculating the threshold voltage of the second TFT.

After step S730, the variation of the threshold voltage of the first TFT is estimated according to the variation of the threshold voltage of the second TFT (step S740). In the present embodiment, the second TFT used as the contrastive group may be the same or different type of transistor as the first TFT, and the voltage supplied to the second TFT may be or may not be the same as the voltage supplied to the first TFT, thus, the variation of the threshold voltage of the first TFT can be estimated by using the variation of threshold voltage of the second TFT calculated in step S730 based on a proportion.

Finally, the source voltage of the first TFT is adjusted according to the variation of the threshold voltage of the first TFT, and the source voltage of the second TFT is adjusted as well (step S750). In the present embodiment, due to the variation of the threshold voltage of the first TFT, change in the gate-source voltage or the drain current of the first TFT may be caused. Thus, after the variation of the threshold voltage of the first TFT is estimated, change in the gate-source voltage or the drain current of the first TFT is compensated by adjusting the source voltage supplied to the first TFT.

Moreover, in the present embodiment, the second TFT is used as the contrastive group of the first TFT, thus, in step S750, the source voltage of the second TFT is also adjusted so that the second TFT can still be used as the contrastive group of the first TFT.

FIG. 8 is a flowchart illustrating a method for increasing circuit reliability according to yet another embodiment of the present invention. In the present embodiment, the circuit includes a first TFT which may be an amorphous Si TFT or other type of TFT. Referring to FIG. 8, first, a second TFT is provided to serve as a contrastive group of the first TFT (step S810). During the actual operation of the circuit, drifts of device parameters may be produced after the TFT is turned on for a long time, for example, variations in threshold voltage, leakage current, and drain current etc. Thus, in the present embodiment, a second TFT which remains on is used as a contrastive group of the first TFT for estimating the variations of device parameters of the first TFT.

Next, steps S820-S840 are the same as steps S720-S740 in FIG. 7, therefore will not be described herein. After the variation of the threshold voltage of the first TFT is estimated, the reference voltage source of the circuit is adjusted according to the variation of the threshold voltage of the first TFT, so as to change the gate voltage of the first TFT, and the gate voltage of the second TFT is adjusted (step S850). In the present embodiment, due to the variation of the threshold voltage of the first TFT, variation in the gate-source voltage or the drain current may be caused to the first TFT. Thus, when the variation of the threshold voltage of the first TFT is estimated, the gate voltage of the first TFT is changed by adjusting the reference voltage source supplied to the circuit, so as to compensate the variation in the gate-source voltage or the drain current of the first TFT.

Moreover, in the present embodiment, since the second TFT is used as the contrastive group of the first TFT, in step S850, the source voltage of the second TFT is also adjusted so that the second TFT can still be used as the contrastive group of the first TFT.

In summary, according to the present invention, the variations of device parameters of a TFT are timely compensated by estimating the variations of the device parameters of the TFT and adjusting the operation environment of the TFT, thus, the driving ability of the TFT can be maintained while the device parameters thereof drift, accordingly the TFT can be more reliable.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A system for increasing circuit reliability, comprising:
a transistor circuit, comprising a first thin film transistor (TFT); and
an estimating/adjusting device, coupled to the transistor circuit, for estimating variations of device parameters of the first TFT to adjust the operation environment of the first TFT.

2. The system as claimed in claim 1, wherein the estimating/adjusting device comprises:
a contrasting unit, for contrasting the first TFT and outputting a contrasting signal; and
an adjusting unit, coupled to the contrasting unit, for estimating variations of device parameters of the first TFT according to the contrasting signal and outputting an adjusting signal to adjust the operation environment of the first TFT.

3. The system as claimed in claim 2, wherein the contrasting unit comprises:
a resistor, having a first terminal for receiving a reference voltage source; and
a second TFT, having a gate for receiving the reference voltage source, a source for receiving the adjusting signal, a drain being coupled to the second terminal of the resistor for outputting the contrasting signal.

4. The system as claimed in claim 3, wherein the adjusting unit receives the contrasting signal, calculates the device parameters of the second TFT to estimate the variations of device parameters of the first TFT, and outputs the adjusting signal.

5. The system as claimed in claim 4, wherein the source of the first TFT receives the adjusting signal to compensate the variations of device parameters of the first TFT.

6. The system as claimed in claim 2, wherein the contrasting unit comprises:
a resistor, having a first terminal receiving the adjusting signal; and
a second TFT, having a gate for receiving the adjusting signal, a source being grounded, a drain being coupled to the second terminal of the resistor for outputting the contrasting signal.

7. The system as claimed in claim 6, wherein the adjusting unit receives the contrasting signal, calculates the device parameters of the second TFT to estimate the variations of device parameters of the first TFT, and outputs the adjusting signal.

8. The system as claimed in claim 7, wherein the transistor circuit receives the adjusting signal, and compensates the variations of device parameters of the first TFT by using the adjusting signal as a reference voltage source.

9. The system as claimed in claim 1, wherein the device parameters of the first TFT comprise threshold voltage, drain current, or leakage current.

10. The system as claimed in claim 1, wherein the operation environment of the first TFT comprises drain current, gate voltage, or source voltage.

11. A method for increasing circuit reliability, the circuit comprising at least a first TFT, the method comprising:
providing a second TFT as a contrastive group of the first TFT;
calculating variations of device parameters of the second TFT; and
adjusting an operation environment of the first TFT according to the variations of device parameters of the second TFT.

12. The method as claimed in claim 11, wherein the step of calculating the variations of device parameters of the second TFT comprises:
measuring an voltage or a current of the second TFT; and
calculating variations of device parameters of the second TFT according to the measured voltage or current of the second TFT.

13. The method as claimed in claim 12, wherein the step of adjusting the operation environment of the first TFT according to the variations of device parameters of the second TFT comprises:
estimating variations of device parameters of the first TFT according to the variations of device parameters of the second TFT; and
adjusting the operation environment of the first TFT according to the variations of device parameters of the first TFT.

14. The method as claimed in claim 13, wherein the step of calculating the variations of device parameters of the second TFT comprises:
measuring a drain voltage of the second TFT; and
calculating variation of the threshold voltage of the second TFT according to the measured drain voltage.

15. The method as claimed in claim 14, wherein the step of adjusting the operation environment of the first TFT according to the variations of device parameters of the second TFT comprises:
estimating a variation of the threshold voltage of the first TFT according to a variation of the threshold voltage of the second TFT; and
adjusting a source voltage of the first TFT according to the variation of the threshold voltage of the first TFT.

16. The method as claimed in claim 15, wherein the step of adjusting the source voltage of the first TFT further comprises adjusting the source voltage of the second TFT.

17. The method as claimed in claim 14, wherein the step of adjusting the operation environment of the first TFT according to the variations of device parameters of the second TFT comprises:
estimating the variation of the threshold voltage of the first TFT according to the variation of the threshold voltage of the second TFT; and
adjusting a reference voltage source of the circuit according to the variation of the threshold voltage of the first TFT, so as to change a gate voltage of the first TFT.

18. The method as claimed in claim 17, wherein the step of adjusting a reference voltage source of the circuit further comprises adjusting a gate voltage of the second TFT.

19. The method as claimed in claim 11, wherein the device parameters of the first TFT comprise threshold voltage, drain current or leakage current.

20. The method as claimed in claim 11, wherein the operation environment of the first TFT comprises drain current, gate voltage or source voltage.
